(19) United States
(12) Patent Application Publication
(10) Pub. No.: US 2009/0193030 A1
(43) Pub. Date: Jul. 30, 2009

(54) ELECTRONIC DEVICE, A DATABASE, SYSTEM, AND METHOD FOR PRESENTING THE CONTENT OF A FILE TO A USER

(76) Inventors: Blagojce GORSEV, Malmo (SE); Goran Stojcevski, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/022,210

(22) Filed: Jan. 30, 2008

(51) Int. Cl. G06F 17/00

(52) U.S. Cl. 707/10; 707/E17.01

(57) ABSTRACT

The invention relates to an electronic device comprising a control unit, a memory comprising a first and a second application, an user interface arranged to enable a file to be selected and to present a content of a file, and a transceiving unit, wherein the control unit is arranged to control the first application to feed a selected file of a first format to the transceiving unit for transmission to a predetermined database, and to control the second application to present the content of the selected file in a second format using data received over the transceiving unit from the pre-determined database sent.

### FIELD OF THE INVENTION

The invention relates to an electronic device, a database, system and method for presenting the content of a file to a user. In particular, embodiments relate to present content of various file types on an electronic device.

### BACKGROUND OF THE INVENTION

Today, there exists many types of electronic devices such as mobile telephones, media players, GPS modules, palmtop computers, cameras etc. Such devices comprise a user control interface having an output device, for example in the form of a display for presenting visual information such as letters, digits and also graphics and symbols as well as a speaker arrangement to present audio information. Furthermore, these devices have a data input interface enabling data input from a user, such as a keypad, a touch screen or the like.

Electronic devices, such as mobile phones or the like, comprising basic functions are well spread and used globally. However, these devices are very restricted to their basic features, for example, the telephone/SMS feature and an Internet browser feature, and are not possible to update with certain features due to, for example, restricted computational capabilities, memory capabilities or the like. Hence, there is a desire to implement further features to electronic devices.

### SUMMARY OF THE INVENTION

Some embodiments of the invention address the need to enable electronic devices to implement further features.

The invention relates to an embodiment wherein an electronic device comprises a control unit, a memory comprising a first and a second application, an user interface arranged to enable a file to be selected and to present a content of a file, and a transceiving unit, wherein the control unit is arranged to control the first application to feed a selected file of a first format to the transceiving unit for transmission to a predetermined database, and to control the second application to present the content of the selected file in a second format using data received over the transceiving unit from the pre-determined database sent.

An embodiment of the electronic device discloses that the data received comprises a network address and the address is arranged to be used in the second application to retrieve the file of the second format.

In an embodiment the data received comprises the file in the second format.

Furthermore, the control unit may be arranged to control a determining application stored in the memory so as to determine the initiation of the first application based on a characteristic of the selected file.

In addition, the initiation may be based on the file type and that the file type is not associated with an application installed on the electronic device.

Additionally, the initiation may be based on the file type and that the file type is in a list stored in the determining application.

In an embodiment is the initiation based on a command from a user.

The electronic device may be a portable device and the user interface may comprise an input arrangement and an output arrangement.

The invention further relates to a database comprising a control unit and a transceiving arrangement, a first memory and a converting application stored in the first memory and arranged to be executed on the control unit, wherein the converting application is further arranged to convert a received file from a first format to a second format and to transmit data to the electronic device arranged to enable the content of the converted file to be presented to the user.

In addition, the application may further be arranged to store the converted file at a second memory.

In an embodiment may the data transmitted to the electronic device comprises a network address associated the converted file.

In an embodiment, the data transmitted may comprise the converted file.

Furthermore, the second format may be a format arranged to be displayed on a portable device.

Additionally, the database may be connected to a network.

In an embodiment of the invention a system is disclosed comprising an electronic device connected to a database over a network, wherein the electronic device comprises; a control unit, a user interface, a transceiving arrangement, a memory with a first application stored thereon and arranged to transmit a selected file of a first format to the database using the transceiving arrangement unit when being executed on the control unit, and a second application stored thereon and arranged to present the content of the selected file in a second format in response to data received from the database; and the database comprises a control unit, a transceiving arrangement, and a first memory with a stored converting application arranged to be executed on the control unit, wherein the converting application is further arranged to convert the received file from a first format to a second format and to send data representing the converted file.

The electronic device may, in an embodiment, be arranged to transmit the file of a first format over the network to the database.

In addition, the data representing the converted file sent from the database may comprise a network address indicating the location of the converted file.

Furthermore, the data representing the converted file may comprise the converted file.

In an embodiment the invention relates to a method for presenting content of a selected file to a user using an electronic device comprising the steps of: transmitting the selected file that is not presentable on the electronic device to a database, receiving the selected file in the first format at the database, converting the file of the first format into a second format using an application run in the database, transmitting data representing the converted file to the electronic device enabling the electronic device to open the selected file, receiving the data representing the converted at the electronic device, and presenting the file in the second format on the electronic device to the user using the received data.

In addition, the step of converting the file to a second format may be followed by storing the file of the second format in a memory, and the step of transmitting data to the electronic device may comprise transmitting information related to location of the stored file, wherein the step of presenting the file may comprise retrieving the file in the second format based on the location information using an application in the electronic device.

The data transmitted by the database may comprise the converted file, and the converted file may be used in an application in the electronic device to present the file to the user.

The method may further comprise a determination step comprising the step of comparing the file format of the selected file with existing formats associated with applications on the electronic device and if no match is found determining that the content of the file is not presentable on the electronic device.

In addition, the method may further comprise a determination step comprising the step of comparing file type of the selected file with predetermined types stored in an application and if a match is found determining that the content of the file is not presentable on the electronic device.

The method may, in an embodiment, further comprise a determination step comprising the step of receiving a command input from a user indicating that the content of the file in the first format is not presentable on the electronic device.

In an embodiment an electronic device comprises application means for opening a file of a format not associated to an application stored on electronic device, being different than the application means, wherein the application means is arranged to transmit the file to a database for conversion of the file into a format associated with an application stored on the electronic device.

Embodiments facilitate the operation of accessing a content of a file performed by a user. In this manner basic electronic devices may perform operations today merely belonging to smart phones or the like, such as opening excel-documents, word-documents, audio-files, or the like.

### BRIEF DESCRIPTION OF THE DRAWINGS

The invention, together with further objectives and advantages thereof, may best be understood by reference to the following description taken in conjunction with the accompanying drawings in which:

FIG. 1 shows a schematic overview of a system for presenting a content of a file;

FIG. 2 shows a schematic flow chart of a method for presenting content of a file to a user,

FIG. 3 shows a schematic flow chart of a method for presenting content of a file to a user,

FIG. 4 shows a schematic overview of a mobile phone, and

FIGS. 5a-5b show schematic overviews of a display of an electronic device.

### DETAILED DESCRIPTION OF EMBODIMENTS OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein as employed in and with a wireless communications device, also denoted a mobile device. In the context of the invention, the mobile device may e.g. be a mobile phone, a PDA (Personal Digital Assistant) or any other type of portable computer such as laptop computer. It should also be noted that the invention may be implemented in other electronic device with communications ability, such as a stationary computers or the like.

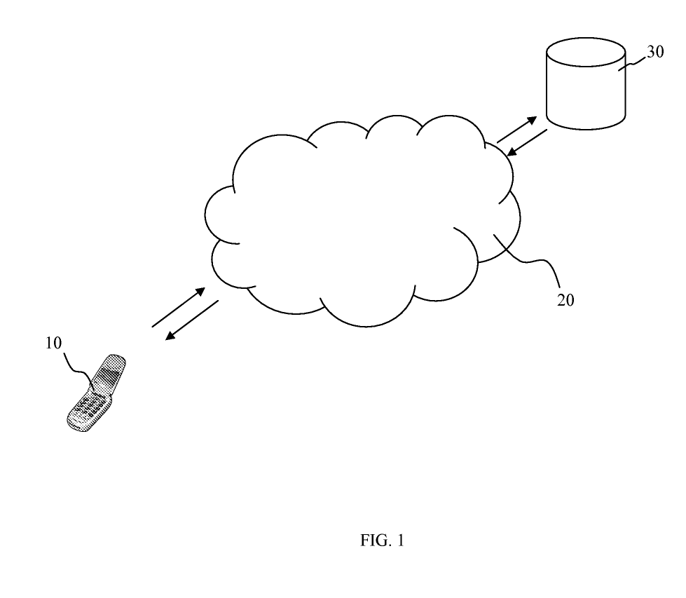

In FIG. 1 a schematic overview of a system for presenting a content of a file to a user is shown. In the illustrated embodiment the user has accessed a document on a mobile device 10 in a format such as a portable document format, pdf, or the like. It should here be noted that the stored file may have been received in a message, from a web page, from a memory of the mobile device or the like. As the user selects the document to be opened by indicating it in any way, for example, by clicking, actively selecting it from a menu, or the like, an application stored in a memory on the mobile device 10 is initiated. The application transmits the document in the first format, in the example as a pdf, to a predetermined database 30 through a network 20, such as Internet, a wireless local area network and/or the like. The database 30 receives the document and converts it into a format enabled to be displayed on a web browser, such as html-, xml-format or the like.

The database 30 may then store the converted document at a network address. The network address of the stored converted document is then transmitted to the mobile device 10 from the database. The mobile device 10 receives the network address and, in an embodiment, automatically initiates the web browser stored on the mobile device 10 and uses the network address to retrieve the document over the network 20 from the database 30, wherein the document is in a format enabled to be displayed on the web browser of the mobile device.

In this way an electronic communications device will work as a viewer of the content of a file independent of the performance of the device. It should be noted that the web address may be received at the mobile device and manually inputted into the address field of the web browser.

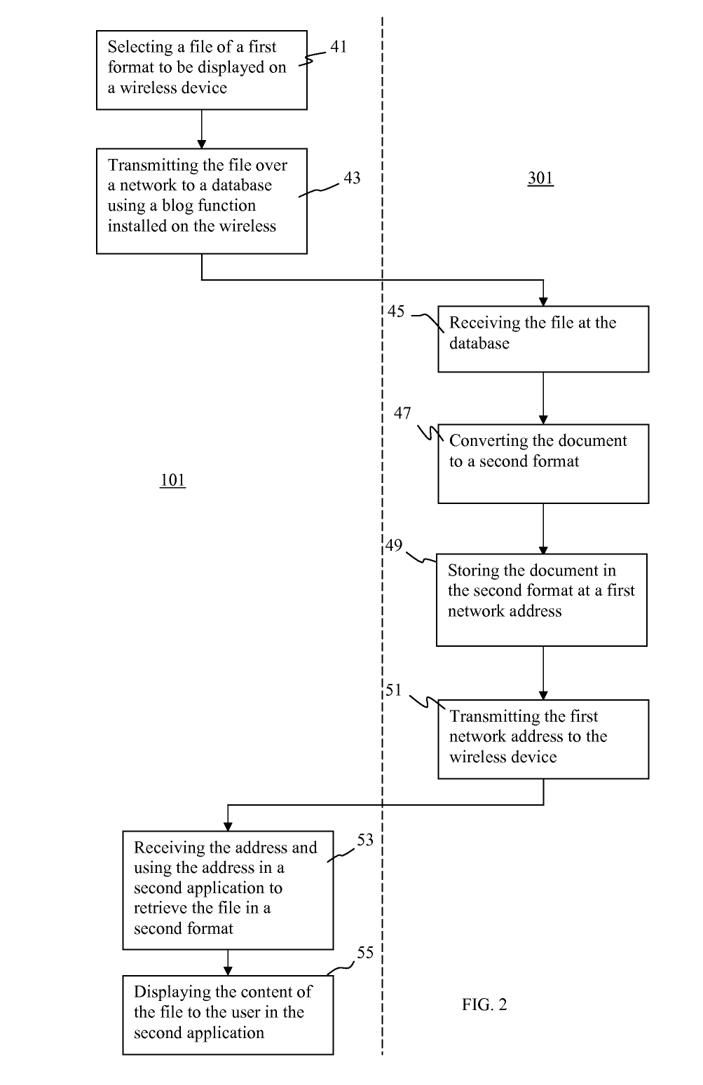

In FIG. 2 a schematic flowchart of a method to present a content of a file to a user using a mobile device is shown. Steps performed at the mobile device are, as above, listed in the left column 101 and steps performed at a database in the right column 301.

In step 41, a user with an electronic device selects a file of a first format to be displayed on the electronic device. The device may be a mobile phone or the like.

As the file is selected the control unit, such as a processor or the like, of the electronic device determines that the file is not associated with an application installed on the electronic device and initiates a transferring function arranged to transmit a file to a database over a network.

In step 43, the initiated transferring function transmits the file over the network to the database. The file may be transmitted in any manner, such as in ftp, data packets over the network, or the like.

In step 45, the database receives the file from the electronic device.

In step 47, the received file is converted in the database using a converting application stored in the database. The file is converted to a second format, such as html-format, xml or the like.

In step 49, the converted file is stored at a network address. The network address may be a local network address of the database or a web address of a different database.

In step 51, the network address of the converted file is transmitted to the electronic device. The web address may be sent to the user in any manner, such as an SMS, mail, link redirecting a web browser or the like.

In step 53, the information, the network address, is received at the electronic device and used in a second application installed on the electronic device. The second application retrieves the file in the second format based on the received information. The second application may be a web browser application retrieving the file in, for example, xml-format.

In step 55, the content of the file is presented to the user in the second format using the second application.

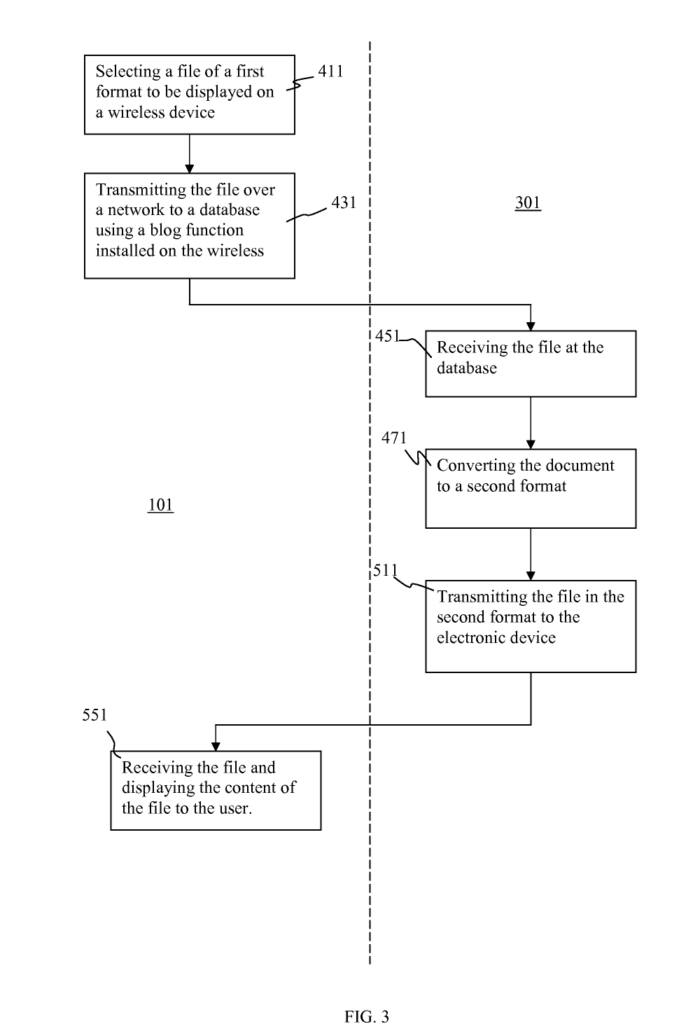

In FIG. 3 a schematic flowchart of an alternative method to present a content of a file to a user using a mobile device is shown. Steps performed at the mobile device are listed in the left column 101 and steps performed at a database in the right column 301.

In step 411, a user with an electronic device selects a file of a first format to be displayed on the electronic device. The device may be a mobile phone or the like.

As the file is selected the control unit, such as a processor or the like, of the electronic device determines that the file is not associated with an application installed on the electronic device and initiates a transferring function arranged to transmit a file to a database over a network.

In step 431, the initiated transferring function transmits the file over the network to the database. The file may be transmitted in any manner, such as in data packets over the network, ftp or the like.

In step 451, the database receives the file from the electronic device.

In step 471, the received file is converted in the database using a converting application stored in the database. The file is converted to a second format, such as html-format or the like.

In step 491, the converted file is transmitted to the electronic device over the network.

In step 551, the file of the second format is received at the electronic device and the content of the file is displayed in an application of the electronic device to the user of the electronic device. The application may be a web browser application receiving the file in, for example, html-format.

The file may be displayed automatically from the opening of the file, that is, the user may only perform an indication of wanting to open the file in order for the method to initiate and perform all the steps.

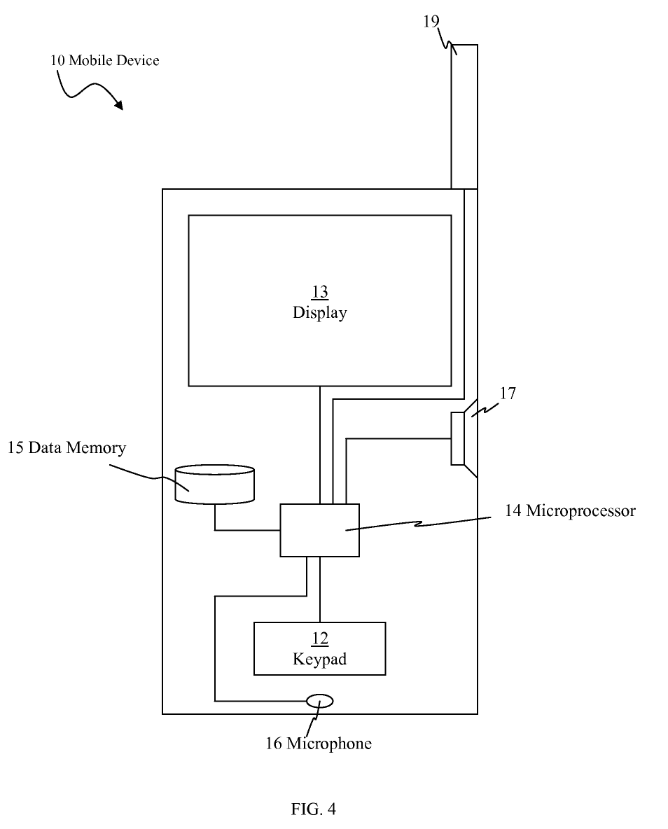

FIG. 4 illustrates an electronic device in the form of a mobile communication terminal 10, such as mobile telephone. Terminal 10 comprises a housing and a user interface including a keypad or keyboard 12 and a display 13. Typically, the user interface also includes an audio interface including a microphone 16 and a speaker 17, radio transceiver circuitry, an antenna 19, a battery, and a microprocessor 14 with software stored on a data memory 15. Applications are stored on the data memory 15 and executed on the control unit 14.

According to an embodiment of the invention a first application stored on the memory 15 is arranged to transmit a file to a converting database when it is detected that the control unit is not able to open said file, that is, the mobile device has not an associated application stored thereon. It should here be noted that the determination to transmit the file may be done on a predetermined basis, that is, different types of files have been listed to initiate said application. The list may then be dynamically updated with new file types or the like. Another way of initiating the application is to initiate the application if no match is found of the file type the user wants to open, that is, the file has no associated program stored on the memory. An alternative way of converting a file to a viewing format is for a user to click on a right mouse button of a mouse on the file and select in a roll down menu, “send to a converting database”.

Furthermore, a second application is stored on the memory 15, being an application arranged to display content, such as a web browser displaying a web page. It should here be noted that the applications may be one and the same, that is, the user may open a file in the browser wherein it is determined that the file is not associated with a program, transmitted to a converting server, and the converted file may be displayed using the same application.

In the database a third application is stored and executed. The third application is arranged to convert a file of a first format into a file of a second format and may be arranged to store the converted file at a location, wherein the format and location enabling the electronic device to present the content to the user of the electronic device.

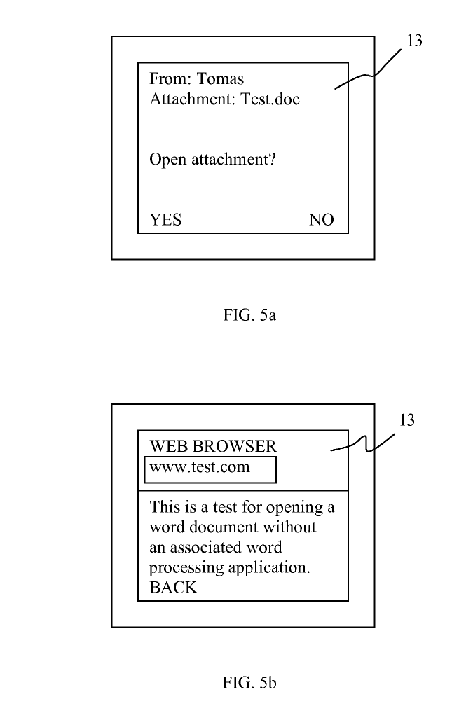

In FIGS. 5a and 5b schematic overviews of a screen display are shown. In FIG. 5a a screen display 13 is shown displaying a received mail containing an attached word document, test.doc. The user has an option of opening the attachment or not. The user indicates the selection either by pressing a corresponding key or a corresponding area on a touch screen.

As the user selects “YES”, the document is transmitted to a database that converts the file into, for example, an html page and stores the page at www.test.com. The address www.test.com is then transmitted to the electronic device and, as shown in FIG. 5b, used in a web browser as a destination address.

The web page www.test.com is retrieved by the browser and the content is displayed to the user in the display 13. The web page may be a personalized page that may be protected from others via a password or the like. The password may be sent to the user of the electronic device along with the address link or in a separate message.

It should be understood that in an alternative embodiment the converted file is transmitted to the mobile device from the database instead of being stored in a memory. In this example the converted file is transmitted to the device and may there be stored locally for viewing at a later time.

The database may be a local server, a web server or the like.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

1. An electronic device comprising a control unit, a memory comprising a first and a second application, an user interface arranged to enable a file to be selected and to present a content of a file, and a transceiving unit, wherein the control unit is arranged to control the first application to feed a selected file of a first format to the transceiving unit for transmission to a predetermined database, and to control the second application to present the content of the selected file in a second format using data received over the transceiving unit from the pre-determined database sent.

2. An electronic device according to claim 1, wherein the data received comprises a network address and the address is arranged to be used in the second application to retrieve the file of the second format.

3. An electronic device according to claim 1, wherein the data received comprises the file in the second format.

4. An electronic device according to claim 1, wherein control unit is arranged to control a determining application stored in the memory so as to determine the initiation of the first application based on a characteristic of the selected file.

5. An electronic device according to claim 4, wherein the initiation is based on the file type and that the file type is not associated with an application installed on the electronic device.

6. An electronic device according to claim 4, wherein the initiation is based on the file type and that the file type is in a list stored in the determining application.

7. An electronic device according to claim 4, wherein the initiation is based on a command from a user.

8. An electronic device according to claim 1, wherein the electronic device is a portable device and the user interface comprises an input arrangement and an output arrangement.

9. A database comprising a control unit and a transceiving arrangement, a first memory and a converting application stored in the first memory and arranged to be executed on the control unit, wherein the converting application is further arranged to convert a received file from a first format to a second format and to transmit data to the electronic device arranged to enable the content of the converted file to be presented to the user.

10. A database according to claim 9, wherein the application is further arranged to store the converted file at a second memory.

11. A database according to claim 10, wherein the data transmitted to the electronic device comprises a network address associated the converted file.

12. A database according to claim 9, wherein the data transmitted comprises the converted file.

13. A database according to claim 9, wherein the second format is a format arranged to be displayed on a portable device.

14. A database according to claim 9, wherein the database is connected to a network.

15. A system comprising an electronic device connected to a database over a network, wherein
the electronic device comprises
a control unit,
a user interface,
a transceiving arrangement,
a memory with a first application stored thereon and arranged to transmit a selected file of a first format to the database using the transceiving arrangement unit when being executed on the control unit, and a second application stored thereon and arranged to present the content of the selected file in a second format in response to data received from the database; and
the database comprising
a control unit,
a transceiving arrangement, and
a first memory with a stored converting application arranged to be executed on the control unit, wherein the converting application is further arranged to convert the received file from a first format to a second format and to send data representing the converted file.

16. A system according to claim 15, wherein the electronic device is arranged to transmit the file of a first format over the network to the database.

17. A system according to claim 15, wherein the data representing the converted file sent from the database comprises a network address indicating the location of the converted file.

18. A system according to claim 15, wherein the data representing the converted file comprises the converted file.

19. A method for presenting content of a selected file to a user using an electronic device comprising the steps of:
transmitting the selected file that is not presentable on the electronic device to a database,
receiving the selected file in the first format at the database,
converting the file of the first format into a second format using an application run in the database,
transmitting data representing the converted file to the electronic device enabling the electronic device to open the selected file,
receiving the data representing the converted at the electronic device, and
presenting the file in the second format on the electronic device to the user using the received data.

20. A method according to claim 19, wherein the step of converting the file to a second format is followed by storing the file of the second format in a memory, and the step of transmitting data to the electronic device comprises transmitting information related to location of the stored file, wherein the step of presenting the file comprises retrieving the file in the second format based on the location information using an application in the electronic device.

21. A method according to claim 19, wherein the data transmitted by the database comprises the converted file, and the converted file is used in an application in the electronic device to present the file to the user.

22. A method according to claim 19, wherein the method further comprises a determination step comprising the step of comparing the file format of the selected file with existing formats associated with applications on the electronic device and if no match is found determining that the content of the file is not presentable on the electronic device.

23. A method according to claim 19, wherein the method further comprises a determination step comprising the step of comparing file type of the selected file with predetermined types stored in an application and if a match is found determining that the content of the file is not presentable on the electronic device.

24. A method according to claim 19, wherein the method further comprises a determination step comprising the step of receiving a command input from a user indicating that the content of the file in the first format is not presentable on the electronic device.

25. An electronic device comprising application means for opening a file of a format not associated to an application stored on electronic device, being different than the application means, wherein the application means is arranged to transmit the file to a database for conversion of the file into a format associated with an application stored on the electronic device.
